(19) United States
(12) Patent Application Publication
(10) Pub. No.: US 2007/0289099 A1
(43) Pub. Date: Dec. 20, 2007

(54) Opening and closing device for notebook computer

(75) Inventor: Sung Tai Jung, Gyunggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/798,466

(22) Filed: May 14, 2007

(30) Foreign Application Priority Data
May 15, 2006 (KR) 10-2006-0043517

(51) Int. Cl. E05D 7/00

(52) U.S. Cl. 16/354

(57) ABSTRACT

Disclosed herein is an opening and closing device for a notebook computer. The opening and closing device includes hinge means for selectively opening and closing a monitor, drive means for driving the hinge means, and power transmission means for transmitting the power of the drive means to the hinge means in parallel. In an embodiment, the power transmission means includes a first gear installed on the hinge means, and a second gear installed on the drive means.

### CROSS REFERENCE TO RELATED APPLICATION

This application claims the benefit of Korean Patent Application No. 10-2006-0043517, filed on May 15, 2006, entitled “Opening and Closing Device for a Note Book Computer”, which is hereby incorporated by reference in its entirety into this application.

### BACKGROUND OF THE INVENTION

1. Field of the Invention

The present invention relates generally to a notebook computer and, more particularly, to an opening and closing device for a notebook computer, which is capable of selectively opening and closing the monitor of the notebook computer, both automatically and manually.

2. Description of the Related Art

A notebook computer is a notebook-sized computer that can be carried and used by an individual. It is also referred to as a “laptop computer” in the sense that a user may put it on his or her lap to use it. Since it has the advantage of portability, it is useful for persons that frequently go on business trips and conduct business while moving around.

The method of opening and closing the monitor of a notebook computer has advanced from a method of manually opening and closing a monitor to a method of automatically opening and closing a monitor. An example of the method of automatically opening and closing a monitor is illustrated in FIG. 5.

As illustrated in FIG. 5, opening and closing devices 300 for a notebook computer are disposed on both sides of a main body 210 so that they are located at the portion where the main body 210 and the monitor 220 of the notebook computer are coupled to each other in a hinged manner. Each of the opening and closing devices 300 includes a hinge assembly 310 and a motor assembly 320.

The main body 210 contains various units, such as an operation unit, a memory unit, and a power supply, and is provided with input units, such as a keyboard (not shown) and a touch pad (not shown), on the top thereof.

The monitor 220 is rotatably installed on one side of the main body 210, has a coupling part 221 to which parts of the hinge assemblies 310 are securely fastened, and is coupled to the motor assemblies 320 via the hinge assemblies 310.

The coupling part 221 protrudes from the lower end of the monitor 220 in a hollow cylindrical form, and accommodates and protects a flexible circuit board (not shown), which is electrically connected to the main body 210 and is used to transmit signals to the monitor 220.

The hinge assembly 310 includes a first hinge shaft 311 coupled to the monitor 220, a second hinge shaft 313 connected to the motor assembly 320, and first and second friction plates 314 and 315 respectively mounted around the first and second hinge shafts 311 and 313.

The first hinge shaft 311 has a fastening tab 312 fastened to the monitor 220 via fastening means, such as bolts, and is rotatably fitted around the second hinge shaft 313.

The second hinge shaft 313 is connected to the motor assembly 320 in series, and is rotated using the power of the motor assembly 320, thereby automatically opening and closing the monitor 220.

The first and second friction plates 314 and 315 are used to apply frictional force to the first and second hinge shafts 311 and 313. The first and second friction plates 314 and 315 are disposed so that they are in contact with each other, and come into tight contact with each other using frictional force therebetween, so that the first and second hinge shafts 311 and 313 are rotated together when the motor assembly 320 is driven, and slip on each other, and thus only the first hinge shaft 311 is rotated when external force is applied to the monitor 220 in the state in which the motor assembly 320 is not driven, and thus the second hinge shaft 313 is stopped.

The motor assembly 320 is used to provide power so as to selectively open and close the monitor 220 automatically, and accommodates a plurality of planetary gears (not shown) so that a specific reduction ratio can be achieved.

The opening and closing devices for a notebook computer, having the above-described construction, are configured such that, when a power switch is turned on, power is applied to the motor assemblies 320 at the same time that a computer system is booted, so that the hinge assemblies 310 are rotated, with the result that the monitor 220 is selectively opened and closed automatically.

Meanwhile, when external force is applied to the monitor 220 in the state in which power is not applied to the motor assemblies 320, only the first hinge shafts 311 are rotated, as the first and second friction plates 314 and 315 of the hinge assemblies 310 slide, so that the monitor 220 is opened and closed manually.

However, the prior art opening and closing devices for a notebook computer having the above-described construction have a problem in that the overall length of the monitor becomes excessively large because the motor assemblies are connected to respective hinge assemblies in series.

Furthermore, the prior art opening and closing devices have another problem in that the monitor must be redesigned because the length of the coupling part of the monitor becomes relatively short due to the opening and closing devices installed on both sides of the main body, with the result that it is difficult to apply the prior art opening and closing devices to typical notebook computers.

### SUMMARY OF THE INVENTION

Accordingly, the present invention has been made keeping in mind the above problems occurring in the prior art, and the present invention is intended to provide an opening and closing device, in which the hinge assembly and motor assembly of the opening and closing device for selectively opening and closing the monitor of a notebook computer automatically and manually are arranged in parallel to each other, thereby reducing the overall length of the opening and closing device.

Furthermore, the length of the opening and closing device is reduced to a length that is suitable for the specifications of widely used monitors, so that the application and installation of the opening and closing device to and in monitors can be easily made without modifying the monitors.

In order to accomplish the above object, the present invention provides an opening and closing device for a notebook computer, including hinge means for selectively opening and closing a monitor; drive means for driving the hinge means; and power transmission means for transmitting power of the drive means to the hinge means in parallel.

In an embodiment, the power transmission means includes a first gear installed on the hinge means, and a second gear installed on the drive means.

In addition, the present invention provides an opening and closing device for a notebook computer, including a hinge assembly for selectively opening and closing a monitor; a motor assembly disposed parallel to the hinge assembly and configured to drive the hinge assembly; and first and second gears respectively installed on the hinge assembly and the motor assembly, and configured to transmit power of the motor assembly to the hinge assembly.

In an embodiment, the first gear has the same number of revolutions per minute as that of the second gear.

In an embodiment, the first and second gears are spur gears or helical gears.

In an embodiment, the first gear has a number of revolutions per minute lower than that of the second gear.

In an embodiment, the first and second gears are spur gears or helical gears.

In an embodiment, the hinge assembly comprises a first hinge shaft installed on the monitor, a second hinge shaft installed on the first gear, and first and second friction plates installed on the first and second hinge shaft and configured to come into contact with each other, and the first hinge shaft is rotated along with the second hinge shaft due to frictional force between the first and second friction plates when the power is transmitted, and is rotated independently of the second hinge shaft when external force is applied to the monitor.

In an embodiment, the opening and closing device further includes a housing for accommodating the hinge assembly, the motor assembly and the first and second gears, and part of the hinge assembly protrudes from the housing and is fastened to the monitor.

### BRIEF DESCRIPTION OF THE DRAWINGS

The above and other objects, features and advantages of the present invention will be more clearly understood from the following detailed description, taken in conjunction with the accompanying drawings, in which:

FIG. 1 is a schematic perspective view showing a notebook computer to which opening and closing devices according to a preferred embodiment of the present invention are installed;

FIG. 2 is a schematic perspective view showing the opening and closing device of FIG. 1;

FIG. 3 is a schematic perspective view showing an opening and closing device according to another embodiment of the present invention;

FIG. 4 is a schematic sectional view showing the opening and closing device of FIG. 1; and

FIG. 5 is a schematic perspective view showing a notebook computer to which prior art opening and closing devices are installed.

### DESCRIPTION OF THE PREFERRED EMBODIMENTS

Reference now should be made to the drawings, in which the same reference numerals are used throughout the different drawings to designate the same or similar components.

Referring to the accompanying drawings, an opening and closing device 100 for a notebook computer according to a preferred embodiment of the present invention will be described in detail below.

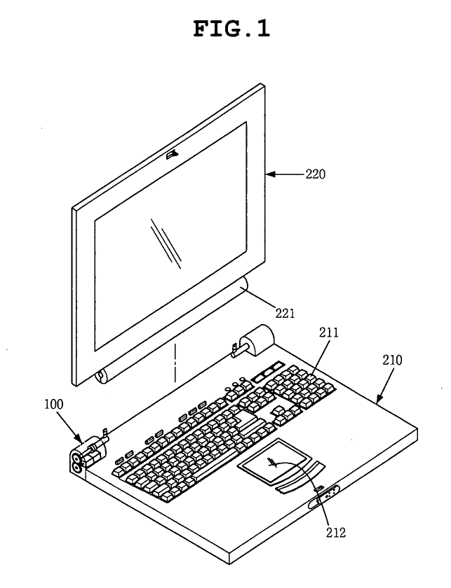

As shown in FIG. 1, opening and closing devices 100 for a notebook computer according to the present embodiment are installed on both sides of a main body 210 so that they are located at the portion where the main body 210 and the monitor 220 are coupled to each other in a hinged fashion. An ON/OFF switch (not shown) for operating the opening and closing devices 100 is disposed on the main body 210 at a specific location.

The main body 210 contains various units, such as an operation unit, a memory unit, and a power supply, and is provided with input units, such as a keyboard 211 and a touch pad 212, on the top thereof.

The monitor 220 is rotatably installed on one side of the main body 210, and has a coupling part 221 to which parts of the opening and closing devices 100 are securely fastened.

The coupling part 221 protrudes from the lower end of the monitor 220 in a hollow cylindrical form, and accommodates and protects a flexible circuit board (not shown), which is electrically connected to the main body 210 and is used to transmit signals to the monitor 220.

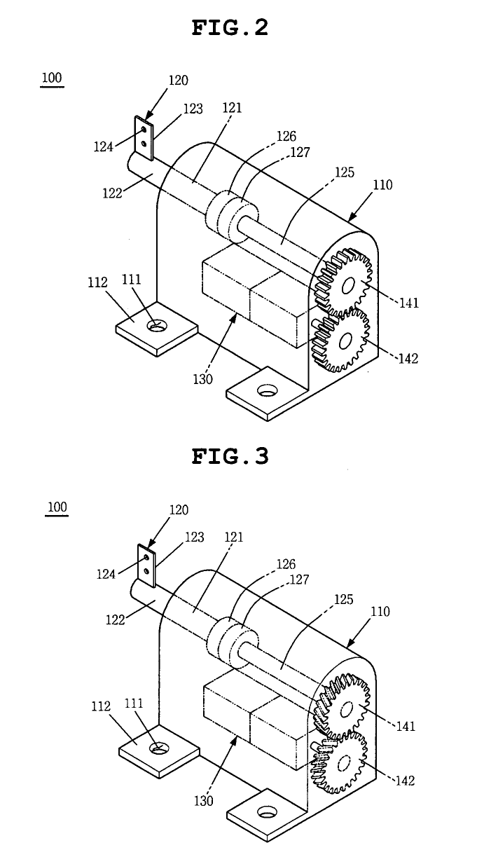

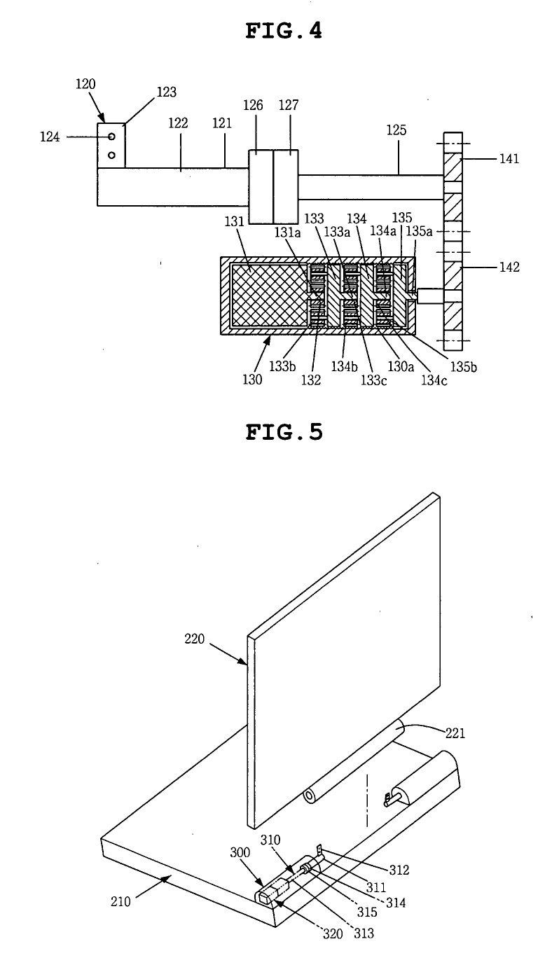

As shown in FIGS. 2 to 4, each of the opening and closing devices 100 for a notebook computer includes a housing 110, a hinge assembly 120, a motor assembly 130, and first and second gears 141 and 142.

The housing 110 is configured to accommodate a hinge assembly 120, a motor assembly 130, and first and second gears 141 and 142. The housing 110 can be installed on the main body 210 of the notebook computer as a single module because the housing 110 has fastening tabs 112, in which fastening holes 111 are formed in order to fasten the housing 110 to the main body 210.

The housing 110 has an opening (not shown) at a location opposite the monitor 220, so that part of the hinge assembly 120 is exposed outside the housing 110.

The hinge assembly 120 is used to couple the motor assembly 130 to the monitor 220 and to selectively open and close the monitor 210. The hinge assembly 120 includes a first hinge shaft 121, a second hinge shaft 125, and a pair of friction plates 126 and 127.

The first hinge shaft 121 has an approximate L shape, and includes a horizontal part 122 and a vertical part 123.

The horizontal part 122 is formed to have at least a part protruding from the housing 110, and is rotatably coupled to the second hinge shaft 125. The vertical part 123 is formed perpendicular to the protruding part of the horizontal part 122, and has coupling holes 124 so that the vertical part 123 can be coupled to the monitor 220 using coupling means such as bolts.

The second hinge shaft 125 is rotatably coupled to the horizontal part 122 of the first hinge shaft 121. The first gear 141, installed on one end of the second hinge shaft 125, engages with the second gear 142 of the motor assembly 130, and is thus rotated using the power of the motor assembly 130.

The pair of friction plates 126 and 127 includes a first friction plate 126 fastened to the horizontal part 122 of the first hinge shaft 121, and a second friction plate 127 fastened to the second hinge shaft 125 so that the second friction plate 127 comes into contact with the first friction plate 126.

Here, when the second hinge shaft 125 is rotated using the power of the motor assembly 130, the first and second friction plates 126 and 127 come into contact with each other due to the frictional force therebetween, and are rotated along with the first and second hinge shafts 121 and 125.

When external force is applied to the monitor 220, the first and second friction plates 126 and 127 slip on each other, so that the first hinge shaft 121 can be rotated independently of the non-rotating second hinge shaft 125. Here, the load of the frictional force between the first and second friction plates 126 and 127 is greater than the torque of the power of the motor assembly 130, but it is less than the torque of the external force applied to the monitor 220.

Although, in the present embodiment, the first hinge shaft 121 is formed in an approximate L shape, the first hinge shaft 121 may be formed in any shape that is suitable for the coupling of the second hinge shaft 125 to the monitor 220.

The motor assembly 130 is configured to provide power for selectively opening and closing the monitor 210 and for driving the hinge assembly 120. The motor assembly 130 is disposed parallel to the hinge assembly 120, and is fastened inside the housing 110.

The motor assembly 130 contains a motor 131, a plurality of carriers 133, 134 and 135, and a plurality of planetary gears 133b, 134b and 135b. A thread 130a is formed in the inner wall of the motor assembly 130, and engages with the plurality of planetary gears 133b, 134b and 135b.

The motor 131 is installed in one side of the motor assembly 130, and a motor gear 132 is fastened around a motor shaft 131a.

The first carrier 133 is formed in a disk shape. A first central shaft 133a, around which a first shaft gear 133c is rotatably fitted, is formed on one side of the first carrier 13, and a plurality of first planetary gears 133b, for example, in the present embodiment, three first planetary gears 133b, is rotatably disposed on the other side of the first carrier 13. Here, the first planetary gears 133b engage with a motor gear 132 and the thread 130a formed on the motor assembly 130.

The second carrier 134 is formed to have a disk shape. A second central shaft 134a, around which a second shaft gear 134c is rotatably installed, is formed on one side of the second carrier 134, and a plurality of second planetary gears 134b, for example, in the present embodiment, three second planetary gears 134b, is rotatably disposed on the other side of the second carrier 134. Here, the second planetary gears 134b engage with the first shaft gear 133a and the thread 130a formed on the motor assembly 130.

The third carrier 135 is formed to have a disk shape. A third central shaft 135a is formed on one side of the third carrier 135, and a plurality of third planetary gears 135b, for example, in the present embodiment, three third planetary gears 135b, is rotatably disposed on the other side of the third carrier 135. Here, the third planetary gears 135b engage with the second shaft gear 134a and the thread 130a formed on the motor assembly 130, and the third central shaft 135a protrudes from the motor assembly 130 and is fitted into the second gear 142.

The first and second gears 141 and 142 are used to transmit the power of the motor assembly 140 to the hinge assembly 130, and are respectively installed on the second hinge shaft 125 of the hinge assembly 120 and the third central shaft 135a of the motor assembly 130.

As illustrated in FIG. 2, the first and second gears 141 and 142 of the present invention are spur gears, in each of which a thread is formed on the circumferential surface of the gear parallel to the second hinge shaft 125 or the third central shaft 135a. The first and second gears 141 and 142 are installed on the hinge assembly 120 and the motor assembly 130, which are disposed parallel to each other, and serve to transmit the power of the motor assembly 130 to the hinge assembly 120 in a parallel manner.

Here, the first gear 141 has the same diameter as the second gear 142, and thus has the same number of Revolutions Per Minute (RPM) as the second gear 142, so that the power of the motor assembly 130 can be transmitted to the hinge assembly 120 without change.

Alternatively, the first gear 141 may be formed to have a diameter greater than that of the second gear 142, so that the first gear 141 has a number of RPM lower than that of the second gear 142, so that a specific reduction ratio may be established between the first gear 141 and the second gear 142.

As illustrated in FIG. 3, the first and second gears 141 of another embodiment of the present invention are helical gears, in each of which a thread is formed in the circumferential surface of the gear in a direction inclined with respect to the second hinge shaft 125 or the third central shaft 135a. The first and second gears 141 are respectively installed on the hinge assembly 120 and the motor assembly 130, which are disposed parallel to each other, and serve to transmit the power of the motor assembly 120 to the hinge assembly 130 in a parallel manner.

Here, the first gear 141 has the same diameter as the second gear 142, and thus has the same number of RPM as the second gear 142, so that the power of the motor assembly 130 can be transmitted to the hinge assembly 120 without change.

Alternatively, the first gear 141 may be formed to have a diameter greater than that of the second gear 142, so that the first gear 141 has a number of RPM lower than that of the second gear 142, so that a specific reduction ratio may be established between the first gear 141 and the second gear 142.

The operation of the opening and closing device 100 for a notebook computer according to the present invention will be described in detail below.

When external power is applied to the motor assembly 130, particularly the motor 131, so as to selectively open and close the monitor 220 automatically, the motor 131 is operated, the plurality of carriers 133, 134, and 135 and the plurality of planetary gears 133b, 134b, and 135b connected to the motor 131 are operated, and then the second gear 142 connected to the motor assembly 130 is rotated. Furthermore, as the first gear 141, engaging with the second gear 142, is rotated, the second hinge shaft 125 is rotated.

In this case, since the load of the frictional force between the first friction plate 126 and the second friction plate 127 is greater than the torque of the power of the motor assembly 130, the first hinge shaft 121 is rotated along with the second hinge shaft 125, so that the monitor 220 is selectively opened and closed automatically.

Meanwhile, when external force is applied to the monitor 220 in the state in which external power is not applied to the motor assembly 130, particularly the motor 131, that is, when the motor 131 is stopped, in order to selectively open and close the monitor 220 manually, the external force is transmitted to the first hinge shaft 121 and the second hinge shaft 125.

In this case, since the load of the frictional force between the first friction plate 126 and the second friction plate 127 is less than the torque of the external force, the first friction plate 126 slips on the second friction plate 127 and is rotated, so that only the first hinge shaft 121 is rotated independently, and thus the monitor 220 can be selectively opened and closed manually.

According to the opening and closing device for a notebook computer according to the present invention, the hinge assembly and the motor assembly are disposed in parallel and face each other, and the hinge assembly and the motor assembly are coupled to each other via the first and second gears, so that power can be transmitted in parallel, thereby reducing the overall length of the opening and closing devices for a notebook computer.

Furthermore, the opening and closing device is suitable for the specifications of widely used monitors, and thus it can be applied to existing notebook computers without requiring that the monitors be modified.

Moreover, the reduction ratio of the opening and closing device can be easily adjusted by varying the diameters of the first and second gears, without modifying planetary gears.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An opening and closing device for a notebook computer, comprising:
hinge means for selectively opening and closing a monitor;
drive means for driving the hinge means; and
power transmission means for transmitting power of the drive means to the hinge means in parallel.

2. The opening and closing device as set forth in claim 1, wherein the power transmission means comprises a first gear installed on the hinge means, and a second gear installed on the drive means.

3. The opening and closing device as set forth in claim 2, wherein the first gear has a number of revolutions per minute identical to a number of revolutions per minute of the second gear.

4. The opening and closing device as set forth in claim 3, wherein the first and second gears are spur gears or helical gears.

5. The opening and closing device as set forth in claim 2, wherein the first gear has a number of revolutions per minute lower than a number of revolutions per minute of the second gear.

6. The opening and closing device as set forth in claim 5, wherein the first and second gears are spur gears or helical gears.

7. An opening and closing device for a notebook computer, comprising:
a hinge assembly for selectively opening and closing a monitor;
a motor assembly disposed parallel to the hinge assembly and configured to drive the hinge assembly; and
first and second gears respectively installed on the hinge assembly and the motor assembly, and configured to transmit power of the motor assembly to the hinge assembly.

8. The opening and closing device as set forth in claim 7, wherein the first gear has a number of revolutions per minute identical to a number of revolutions per minute of the second gear.

9. The opening and closing device as set forth in claim 8, wherein the first and second gears are spur gears or helical gears.

10. The opening and closing device as set forth in claim 7, wherein the first gear has a number of revolutions per minute lower than a number of revolutions per minute of the second gear.

11. The opening and closing device as set forth in claim 10, wherein the first and second gears are spur gears or helical gears.

12. The opening and closing device as set forth in claim 7, wherein:
the hinge assembly comprises a first hinge shaft installed on the monitor, a second hinge shaft installed on the first gear, and first and second friction plates installed on the first and second hinge shaft and configured to come into contact with each other; and
the first hinge shaft is rotated along with the second hinge shaft due to frictional force between the first and second friction plates when the power is transmitted, and is rotated independently of the second hinge shaft when external force is applied to the monitor.

13. The opening and closing device as set forth in claim 7, further comprising a housing for accommodating the hinge assembly, the motor assembly and the first and second gears;
wherein part of the hinge assembly protrudes from the housing and is fastened to the monitor.
